(19) United States
(12) Patent Application Publication
(10) Pub. No.: US 2011/0164846 A1
(43) Pub. Date: Jul. 7, 2011

(54) FIBER OPTIC ROTARY JOINT USING TEC FIBER

(76) Inventors: Boying B. Zhang, Pennington, NJ (US); Hong Zhang, Pennington, NJ (US)

(21) Appl. No.: 12/652,895

(22) Filed: Jan. 6, 2010

(51) Int. Cl. G02B 6/26; G02B 6/36

(52) U.S. Cl. 385/26

(57) ABSTRACT

A fiber optic rotary joint is invented using TEC (Thermally Expanded Core) fiber. This device has a rotatable optic TEC fiber and a stationary optic TEC fiber in an assembly to convey a light beam in the optic TEC fibers. The assembly also includes a stationary optic TEC fiber holder for fixing the tip of stationary optic TEC fiber in a central hole and a rotatable optic TEC fiber holder for fixing the body of the rotatable optic TEC fiber with the tip of the rotatable optic TEC fiber protruding out of the rotatable optic TEC fiber holder. The two optic TEC fiber holders can be rotated relative to each other so as to allow the tip of rotatable optic TEC fiber to rotate in the central hole on the stationary optic TEC fiber holder with the facets of the two optic TEC fiber adjacent very closely.

### BACKGROUND OF THE INVENTION

1. Field of the Invention

The invention is related to single channel fiber optic rotary joint in the field of optic communication to ensure that the device has low insertion loss, small insertion loss variation, and high return loss.

2. Description of Related Art

The Fiber optic Rotary Joint is the optic equivalent of the electrical slip ring. It allows uninterrupted transmission of an optic signal in a fiber guide through a rotational interface to a stationary apparatus. The Fiber optic Rotary Joint is widely used in missile guidance systems, robotic systems, remotely operated vehicles, oil drilling systems, sensing systems, and many other field applications where a twist-free fiber cable is essential. Combined with electrical slip rings or fluid rotary joints, Fiber optic Rotary Joint adds a new dimension to traditional slip rings. As fiber optic technology advances, more and more traditional slip ring users will benefit from Fiber optic Rotary Joint in their new fiber systems.

Comparing with its electrical counterpart, the electrical slip ring, the Fiber optic Rotary Joint is not easy to fabricate because the transmission of the light beam through a fiber is strongly depend on its geometrical structure and related position. So it requires special design to ensure the transmission of light beam through a relative rotating joint without suffering a large loss. A couple of prior inventions of single channel fiber optic rotary joint are descried in the following patents: U.S. Pat. No. 5,039,193, U.S. Pat. No. 4,124,272, U.S. Pat. No. 5,633,963, and U.S. Pat. No. 5,949,929. Most of them employ the expanded beam technology, i.e., using lenses to expand the light beam and collimate it before transmitting through a rotary joint. The beam is then refocused and aligned with the receiving fiber. The lenses include graded index rod lens (GRIN lens), and aspheric lens. This method has several significant drawbacks. First, this kind of rotary joint require special fixture to have lenses aligned. Secondly, using high quality lenses would increase the sizes and cost of fiber optic rotary joints. Further, to maintain the axial alignment is difficult so that this kind of rotary joint is vulnerable in such environments as temperature change, vibration, and shock.

### SUMMARY OF THE INVENTION

The first object of the present invention is to minimize the need for maintaining precise axial alignment between the rotating and non-rotating elements of a single channel fiber optic rotary joint so that it could be used in any harsh environments such as temperature change, vibration and shock.

Another object of the present invention is to provide a single channel fiber optic rotary joint with a very low-profile and compact design.

A further objective of the preset invention is to reduce the insertion loss and increase return loss and to allow the rotary joint to work at any ambient pressure by filling index-matching fluid.

### BRIEF DESCRIPTION OF THE DRAWINGS

FIG. 1 is a sectional sketch of TEC fiber;

FIG. 2A and FIG. 2B shows the difference between fibers without TEC treatment (FIG. 2A) and with TEC treatment (FIG. 2B);

FIG. 3 is a cross section view of one embodiment of the invention. There are a rotatable optic TEC fiber and a stationary optic TEC fiber to convey a light beam in a rotary interface.

### DETAILED DESCRIPTION OF THE INVENTION

A TEC fiber is fabricated such that a flame is applied in close proximity to an optic fiber, using a torch which generates a high temperature heat and then the optic fiber is thermally treated at a high temperature lower than the fusion point to expand the core of the optic fiber. So the TEC fiber is called Thermally expand core fiber. It is a significant fiber device to reduce the coupling loss induced by optical alignment error between two different core Single Mode (SM) fibers and between the SM fiber and the laser diode, and during assembling of optical TEC fibers. It is much easier for the alignment of TEC fibers comparing with conventional optic fibers without use of collimators.

As illustrated in FIG. 1, the core 33 of an optic fiber 32 is thermally expanded as 31.

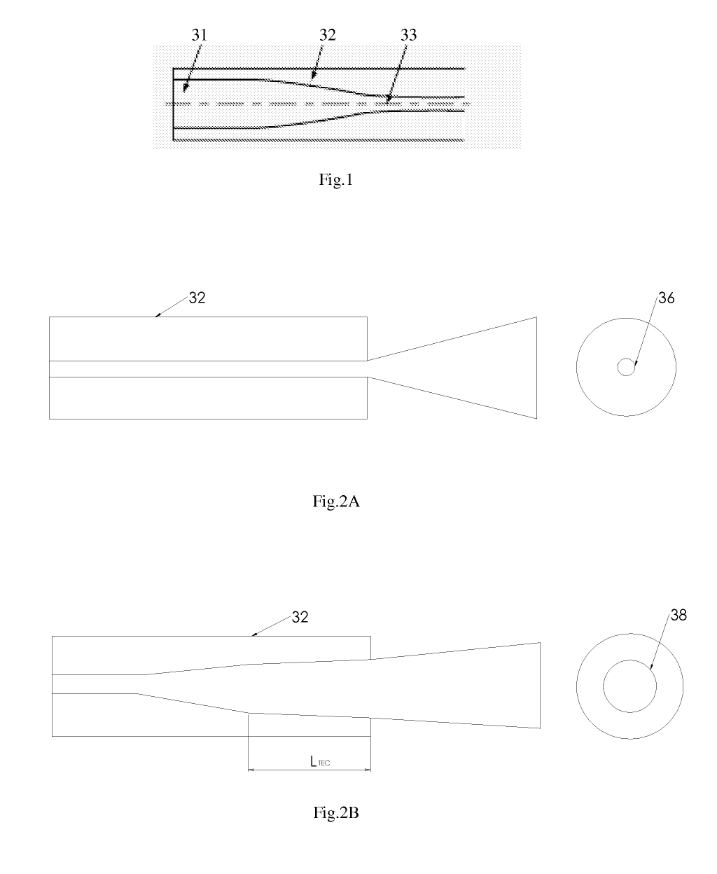

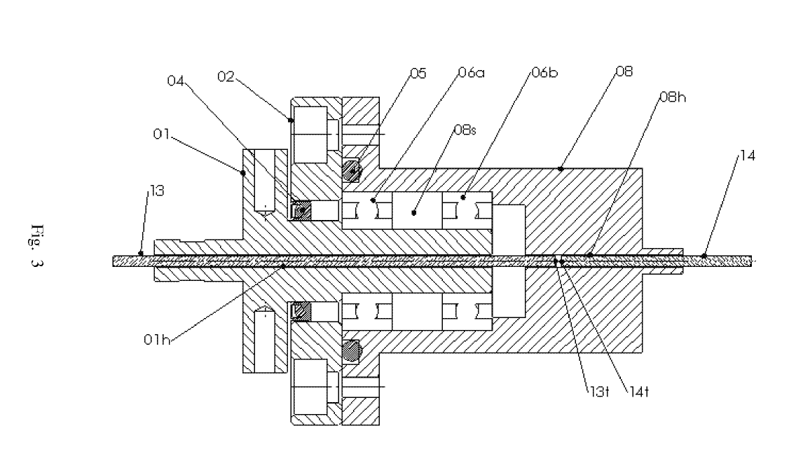

FIG. 2A and FIG. 2B shows the difference between fibers without TEC treatment and with TEC treatment. Fiber 32 has a normal core 36 in FIG. 2A before TEC treatment and after TEC treatment the core is significantly enlarged as 38 in FIG. 2B. This makes the fiber coupling efficiency increases considerably.

As shown in FIG. 3, a typical design of the present invention comprises a rotatable TEC fiber holder 01 and a stationary TEC fiber holder 08. A pair of bearing 06a and 06b are mounted in the bore of stationary TEC fiber holder 08 and on the shaft of rotatable TEC fiber holder 01 so that the rotatable TEC fiber holder 01 is able to rotate around the axis of the bore of stationary TEC fiber holder 08.

Both rotatable TEC fiber holder 01 and a stationary TEC fiber holder 08 are designed with a through central holes 01h and 08h respectively. A rotatable optic TEC fiber 13, having a tip 13t, is fixed in the central hole Olh of the rotatable TEC fiber holder 01 with the tip 13t protruded out of the rotatable TEC fiber holder 01. A stationary optic TEC fiber 14, having a tip 14t, is fixed in the central hole 08h of stationary TEC fiber holder 08 with the tip 14t recessed in the central hole 08h of the stationary TEC fiber holder 08. The tip 13t and 14t are adjacent very closely. Because the diameter of hole 08h is slightly larger than the diameter of TEC fiber 13, the tip 13t of fiber 13 and the central hole 08h of the stationary TEC fiber holder 08 mechanically forms a so-called “micro bearing”, or “micro rotational interface”. When the rotatable TEC fiber holder 01 rotates relative to the stationary TEC fiber holder 08, the rotatable optic TEC fiber 13 is able to rotate relatively to the stationary optic TEC fiber 14 co-axially so as to transmit the optic signal from one optic TEC fiber to another optic TEC fiber bi-directionally.

The length of protrusion portion of the optic TEC fiber 13 is deliberately designed to have enough flexibility to compensate the mechanical alignment error of the two TEC fibers provided by bearings 06a and 06b. The mechanical alignment error of an optical rotary joint could be 10 to 20 um by a conventional fabrication and assembly procedure. For the present invention, the maximum alignment error of the TEC fiber 13a and fiber 13b is only about 0.5 um so that the insertion loss is greatly improved.

Because collimated light beams is much easier for alignment, the optic TEC fibers, 13 and 14, could be single mode, or multi-mode micro fiber optic collimator. A micro-collimator can be as small as a conventional TEC fiber itself in diameter. The micro-collimator could be formed by fusion splicing a GRIN-fiber lens to a fiber, or using a so-called lensed optical fiber, i.e., the lens is directly and integrally formed on an end surface of the fiber. So the TEC fiber can be replaced with micro-collimator in the present invention.

And by using of the “micro bearing”, the whole size of the fiber optical rotary joint could be greatly reduced.

An index matching fluid is tilled in the inner open space 08s of the stationary fiber holder 08. The shaft seal 04 and o-ring 05 are utilized to seal the space 08s. One function of the index matching fluid is for the lubrication between bearings and the “micro bearing”. Another function of index matching fluid is for pressure compensating purposes. The whole space 08s inside the stationary fiber holder 08 could be used as the pressure compensation chamber. The shaft seal 04 is located between the shaft of rotatable fiber holder 01 and the bore of seal cover 02. The space from seal 04 to bearing 06a is designed large enough to allow the shaft seal 04 to slide axially like a piston to balance ambient pressure with the pressure inside the stationary fiber holder 08.

I claim:

1. A fiber optic rotary joint comprising:
a first holder having a through hole for optic TEC fiber mounting on one side and an inner open space co-axially on another side;
a second holder having a through hole for optic TEC fiber mounting and the said second holder rotatably mounted in the said inner open space of said first holder with the axis of said through hole of said first holder aligned to the axis of said through hole of said second holder;
a first optic TEC fiber with a tip, a tail and longitudinal axis; said first optic TEC fiber being firmly mounted in the said through hole of said first holder with the tip of said first optic TEC fiber recessing in the said through hole of said first fiber holder so that the said through hole of said first holder is partially blocked by the said first optic TEC fiber;
a second optic TEC fiber having a tip, a tail and longitudinal axis; said second optic TEC fiber being firmly mounted in the said through hole of said second holder with the tip of said second optic TEC fiber protruding out of said second holder and get into the said through hole of said first holder; and
a shaft seal mounted on said second holder for sealing the said inner open space of said first holder.

2. The fiber optic rotary joint of claim 1, wherein said the diameter of the said through hole in said first holder being slightly larger than the diameter of said second optic TEC fiber; the distance between the tips of said first optic TEC fiber and said second optic TEC fiber being less than 10 times of the diameter of the said second optic fiber.

3. The fiber optic rotary joint of claim 1, wherein said first optic TEC fiber and said second optic TEC fiber can be a micro-collimator with same diameter as of TEC fiber.
